(19) United States
(12) Patent Application Publication
(10) Pub. No.: US 2022/0105884 A1
(43) Pub. Date: Apr. 7, 2022

(54) CONNECTOR PROTECTOR HAVING A POCKET FOR FORMING A SEAL

(71) Applicant: Sumitomo Wiring Systems, Ltd., Yokkaichi-shi (JP)

(72) Inventor: Katsuo Maxted, Farmington Hills, MI (US)

(21) Appl. No.: 17/061,507

(22) Filed: Oct. 1, 2020

(51) Int. Cl. B60R 16/02; H01R 13/52

(52) U.S. Cl. CPC B60R 16/0215; H01R 13/5213; H01R 13/5205; H01R 13/5216

(57) ABSTRACT

A connector protector for protecting an electrical connection between a wire and an electrical connector includes a body member. The body member has a through hole for accommodating the wire. One end of the body member includes a mouth portion and the other end includes a connector cover portion configured to cover the electrical connector. The mouth portion includes a lip having a first diameter that is greater than a second diameter of a through-hole of the body member is as to define a pocket. The pocket is configured to bound a circumference of the wire and is configured to hold a resin so as to form a water-tight seal between the body and the wire. In one aspect, the resin and the body member is formed of a thermoplastic polyurethane. The resin is melted so as to fuse with the body member.

### TECHNICAL FIELD

The present specification generally relates to a connector protector configured to form a watertight seal with a wire.

### BACKGROUND

Connector protectors are used to protect an electrical connection between a wire 200 and an electrical connector 700. An illustrative view of a connector protector of the prior art is shown in FIG. 1. The connector protector 500 includes a body member 502 having a mouth portion 504 wherein a through hole 506 extends through the mouth portion 504 and the body member 500. A connector cover portion 508 is contiguous with the body member 500 and is configured to fit over the electrical connector 700. Due to manufacturing tolerances, a gap 800 may occur between an inner surface of the mouth portion 504 and the outer surface of the wire 200. This gap 800 may allow for water to seep into contact with the electrical connector.

Accordingly, it is desirable to have a connector protector which may close a gap resulting from the manufacturing tolerances so as to form a water tight seal between the mouth of a connector protector and the wire.

### SUMMARY

A connector protector for protecting an electrical connection between a wire and an electrical connector is provided. The connector protector includes a body member having a through hole for accommodating the wire. One end of the body member includes a mouth portion and the other end includes a connector cover portion. The connector cover portion is configured to cover the electrical connector.

The mouth portion includes a lip having a first diameter that is greater than a second diameter of the portion of the through-hole extending through the body member. The space between the inner surface of the lip and the inner surface of the through hole of the body member defines a pocket when the wire is inserted into the body member. The pocket bounds a circumference of the wire and is configured to hold a resin so as to form a water-tight seal between the body and the wire.

In one aspect, the lip includes an angled surface extending radially from a center of the lip so as to narrow in a direction from the lip to the body member. The body member may be formed of a thermoplastic polyurethane and the resin is a melted thermoplastic polyurethane. Accordingly, the melted thermoplastic polyurethane may fuse with the body member so as to close any gap and form a water tight seal.

In another aspect, the connector protector includes a ring. The ring is disposed within the lip. The ring may be integrally formed within the lip or may be made as a separate piece. An inner surface of the ring has a diameter configured to receive the wire.

In an aspect, where the ring is made as a separate piece, the lip may further include an annular ledge which is recessed with respect to a distal end of the lip. The ring is disposed within the lip.

Preferably, the body member and the ring are made of a same material. For example, the body member and the ring may be formed of a thermoplastic polyurethane. The wire is inserted into the mouth and into the body member and the ring is melted so as to fuse the ring with the mouth forming a water tight seal.

In another aspect, a method of assembling a wiring assembly is also provided. The method includes the step of providing a wire having a wire diameter and providing a connector protector cover having a body member. The body member includes a through hole for accommodating the wire. One end of the body member includes a mouth portion and the other end includes a connector cover portion configured to cover an electrical connector. The mouth portion includes a lip having a first diameter that is greater than a second diameter of a through-hole of the body member. The second diameter is greater than the wire diameter.

The method proceeds to the step of inserting the wire into the through hole, wherein the space between the outer surface of the wire and the inner surface of the mouth and the body member defines a pocket that bounds a circumference of the wire. The method proceeds to the step of placing a resin in the pocket, wherein the resin is hardened so as to form a water-tight seal between the body member and the wire.

In one aspect of the method, the lip includes an angled surface extending radially from a center of the lip so as to narrow in a direction from the lip to the body member. The body member is a formed of a thermoplastic polyurethane and the resin is formed by melting a thermoplastic polyurethane. The melted thermoplastic polyurethane is then fused with the body member.

In yet another aspect of the method, the wire includes a sheath formed of a thermoplastic polyurethane.

In yet another aspect of the method, the resin is in the form of a ring, and the ring is formed of a thermoplastic polyurethane. The ring is melted so as to fuse with the body member and the wire. The method may further include the step of forming an annular ledge in the lip. The annular ledge is recessed with respect to a distal end of the lip and the ring is disposed within the lip.

Accordingly, a connector protector and a method of assembling a wiring assembly is provided that closes any gap resulting from a manufacturing tolerances so as to form a water tight seal between the mouth of a connector protector and the wire.

### BRIEF DESCRIPTION OF THE DRAWINGS

The embodiments set forth in the drawings are illustrative and exemplary in nature and not intended to limit the subject matter defined by the claims. The following description of the illustrative embodiments can be understood when read in conjunction with the following drawings, where like structure is indicated with like reference numerals and in which:

FIG. 1 is a perspective view of a connector protector of the prior art;

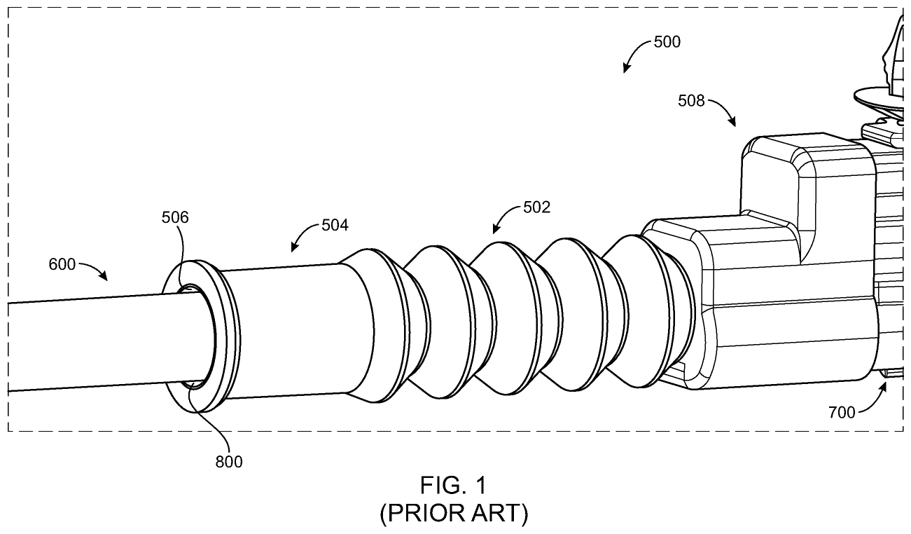

FIG. 2 is a perspective view illustratively depicting a connector protector according to a first embodiment;

FIG. 3 is an exploded view of FIG. 2;

FIG. 4 is a cross-sectional view of the connector protector shown in FIG. 3 taken along line 4-4;

FIG. 5 is a perspective view showing the resin being applied to the connector protector shown in FIG. 2;

FIG. 6 is a perspective view illustratively depicting a connector protector according to a second embodiment.

FIG. 7 is a cross-sectional view of the connector protector shown in FIG. 6 taken along line 7-7;

FIG. 8 is a perspective view showing the resin being applied to the connector protector shown in FIG. 6; and

FIG. 9 is a diagram showing a method of assembling a wiring assembly.

### DETAILED DESCRIPTION OF PREFERRED EMBODIMENTS

Referring generally to the figures, embodiments of a connector protector and a method of assembling a wiring assembly are provided. The connector protector protects an electrical connection between a wire and an electrical connector. The connector protector includes a body member. The body member has a through hole for accommodating the wire. One end of the body member includes a mouth portion and the other end includes a connector cover portion configured to cover the electrical connector. The mouth portion includes a lip having a first diameter that is greater than a second diameter of a through-hole of the body member is as to define a pocket. The pocket is configured to bound a circumference of the wire and is configured to hold a resin so as to form a water-tight seal between the body and the wire. Accordingly, a connector protector and a method of assembling a wiring assembly is provided that closes any gap resulting from a manufacturing tolerances so as to form a water tight seal between the mouth of a connector protector and the wire.

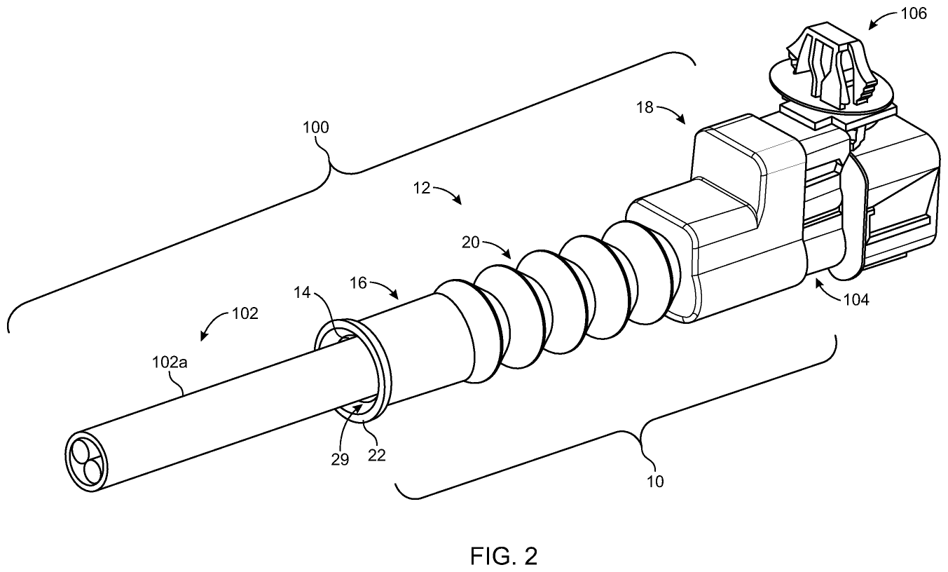

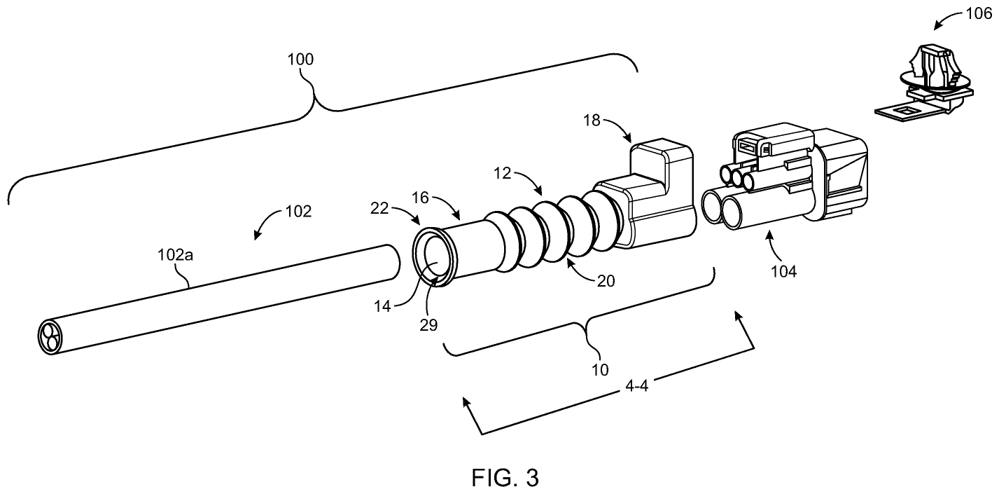

With reference first to FIGS. 2 and 3 a wiring assembly 100 is provided. The wiring assembly 100 includes a wire 102 that is inserted into a connector protector 10. The wiring assembly 100 may be configured for use in various platforms, illustratively including an automotive vehicle. The connector protector 10 covers an electrical connector 104.

The electrical connector 104 is illustratively shown as being configured to receive two wires. The wire 102 as referenced herein, includes an electric conductive member (the two wires) which are bound by a sheath 102a. In such an embodiment, the electric conductive members are each electrically coupled to the electrical connector 104. The electrical connector 104 may include a bracket 106 for attachment onto a substrate (not shown). The connector protector 10 includes a body member 12 having a through hole 14 for accommodating the wire 102. The through hole 14 extends the length of the body member 12 and is dimensioned to receive the wire 102.

One end of the body member 12 includes a mouth portion 16 and the other end includes a connector cover portion 18. The body member 12 may further include a flex portion 20. For illustrative purposes flex portion 20 is shown as a generally corrugated tube. The flex portion 20 extends between the mouth portion 16 and the connector cover portion 18. The flex portion 20 may be desirable in instances where the routing of the wire 102 requires a bend adjacent the electrical connector 104.

The connector cover portion 18 is configured to cover the electrical connector 104. It should be appreciated that the dimension of the connector cover portion 18 is provided herein for illustrative purposes and is configured to be generally the same shape as the electrical connector 104. Accordingly, the shape of the connector cover portion 18 may deviate from what is shown without narrowing the scope of the appended claims.

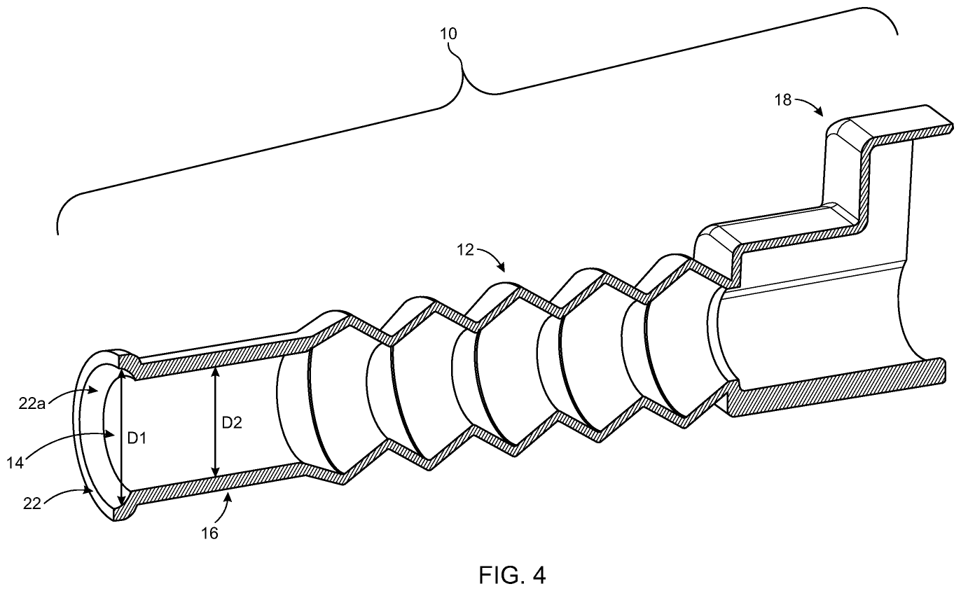

With reference now to FIG. 4, a cross-sectional view of the body member 12 is provided. The mouth portion 16 defines an opening for receiving the wire 102. The mouth portion 16 is contiguous with the flex portion 20 of the body member 12. The mouth portion 16 is a generally cylindrical member having a uniform diameter.

The mouth portion 16 includes a lip 22 disposed on the end of thereof. The lip 22 may have a generally planar front surface. The lip 22 is annular and defines the opening of the mouth portion 16. The front surface of the lip 22 is concentric to the cylindrical portion of mouth portion 16. The lip 22 has a first diameter “D1” as measured by an inner surface of the lip 22. The mouth portion 16 of the body member 12 has a second diameter “D2” as measured by the inner surface of the mouth portion 16 of the body member 12. The first diameter D1 is greater than the second diameter D2.

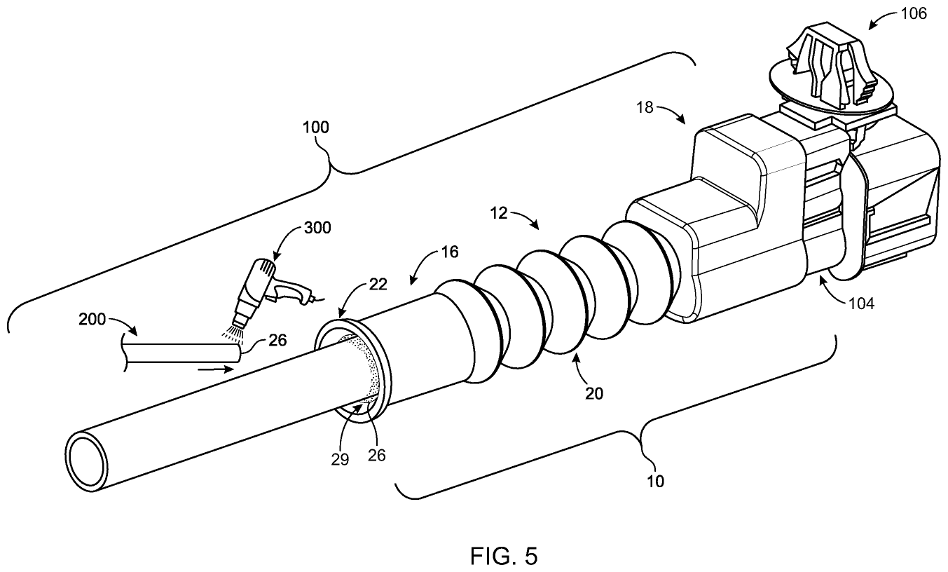

With reference again to FIGS. 2 and 3 and now to FIG. 5, the space between the inner surface of the lip 22 and the inner surface of the mouth portion 26 of the body member 12 defines a pocket 24 when the wire 102 is inserted into the body member 12. The pocket 24 bounds an outer circumference of the wire 102 as indicated in FIG. 2 so as to be annular. The pocket 24 is configured to hold a resin 26 so as to form a water-tight seal between the body and the wire 102. Preferably, the resin 26 is configured to completely fill the pocket 24 so as to bound the outer circumference of the wire 102 and the inner wall of the mouth portion 16. Accordingly, the resin 26 forms a water tight seal between the connector protector 10 and the wire 102.

With reference again to FIG. 4, the lip 22 includes an angled surface 22a extending radially from a center of the lip 22 so as to narrow in a direction from the lip 22 to the body member 12, giving the mouth portion 16 a cone shaped dimension. FIG. 4 depicts the angled surface 22a as being generally obtuse; however, the angled surface 22a may also be generally planar so as to radiate along a constant axis and is generally uniform in length. It should be appreciated that angled surface 22a of the lip 22 is configured to be spaced apart from an outer circumferential surface 102a of the wire 102 so as to form a pocket 24 for which resin 26 may be introduced may deviate from what is shown.

The resin 26 is a material that changes from a liquid state to a solid state. The state change may be accomplished by a temperature change or by curing the resin using curing techniques currently known or later developed. For instance, the resin may be cured with an ultraviolet light. For instance, the resin 26 material may be an adhesive which may be cured to form a solid body. Any such material currently known or later developed may be adapted for use herein, illustratively including a melt-processable elastomer, polypropylene or polyurethane.

In a preferred embodiment, the resin 26 is formed from a thermoplastic polyurethane. The body member 12 may also be formed of a thermoplastic polyurethane and the resin 26 is formed by melting the thermoplastic polyurethane. In particular, the mouth portion 16 of the body member 12 may be formed of a thermoplastic polyurethane. Accordingly, as the thermoplastic polyurethane is melted into the pocket 24, the melted thermoplastic polyurethane fuses with the mouth portion 16 so as to form the water tight seal. The other portions of the body member 12 may be made of a different material. For instance, the connector cover portion 18 may be made of a relatively rigid material such as plastic or the like.

As stated above, the mouth portion 16 may be formed of a thermoplastic polyurethane. The resin 26 is also made of a thermoplastic polyurethane. With reference to FIG. 5, the resin 26 is shown as being a rod 200 made of thermoplastic polyurethane. The tip 26a of the rod 200 is placed near the lip 22 of the mouth portion 16 as indicated by the arrow. A heat source 300 applies heat to melt the tip 26a of the rod 200 filling the pocket 24.

It should be appreciated that the tip 26a of the rod 200 may be moved around the entire outer circumferential surface 102a of the wire 102 so as to completely fill the pocket 24. The melted thermoplastic polyurethane may fuse with the mouth portion 16 so as to close any gap between the inner surface of the mouth portion 16 and the outer circumferential surface 102a of the wire 102. The gap may result from a manufacturing tolerance. The melted resin fuses with the mouth portion 16 so as to form a water tight seal. It should be appreciated that any heat source 300 currently known or later developed that is configured to melt a material such as a thermoplastic polyurethane may be adopted for use herein, illustratively including a heat source commonly known as a soldering 28 gun.

In a preferred embodiment, the wire 102 includes a sheath 102a. The sheath 102a, the resin 26 and the mouth portion 16 are formed of the same material. Preferably, the sheath 102a, the resin 26 and the mouth portion 16 are formed of a thermoplastic polyurethane. Accordingly, the heat source 300 is configured to melt the resin 26 so as to fuse the resin 26 with both the sheath 102a and the mouth portion 16.

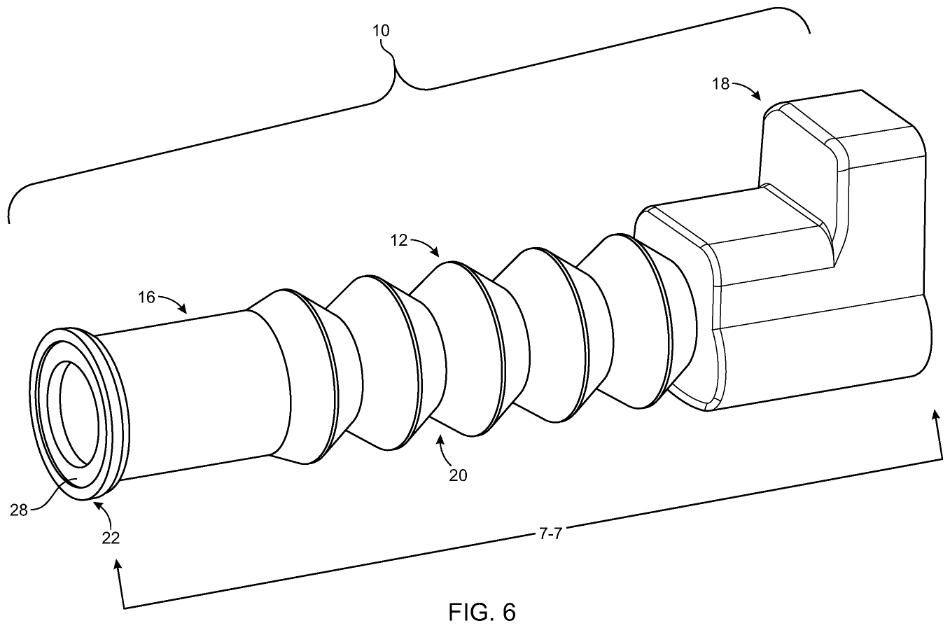

With reference now to FIGS. 6-8 a second embodiment of the connector protector 10 is provided. The connector protector 10 includes a body member 12 having a through hole 14 for accommodating the wire 102. The through hole 14 extends the length of the body member 12 and is dimensioned to receive the wire 102.

One end of the body member 12 includes a mouth portion 16 and the other end includes a connector cover portion 18. The body member 12 may further include a flex portion 20. For illustrative purposes flex portion 20 is shown as a generally corrugated tube. The flex portion 20 extends between the mouth portion 16 and the connector cover portion 18. The flex portion 20 may be desirable in instances where the routing of the wire 102 requires a bend adjacent the electrical connector 104.

The connector cover portion 18 is configured to cover the electrical connector 104. It should be appreciated that the dimension of the connector cover portion 18 is provided herein for illustrative purposes and is configured to be generally the same shape as the electrical connector 104. Accordingly, the shape of the connector cover portion 18 may deviate from what is shown without narrowing the scope of the appended claims.

In the second embodiment, the connector protector 10 includes a ring 28. Preferably, the body member 12 and the ring 28 are made of the same material. For example, the body member 12 and the ring 28 may be formed of a thermoplastic polyurethane. The ring 28 may be integrally formed to the mouth portion 16 or may be made as a separate piece. The ring 28 has a generally planar front and back surface and is disposed within the lip 22 of the mouth portion 16. The ring 28 is illustratively depicted as being integrally formed with the mouth portion 16 of the body member 12.

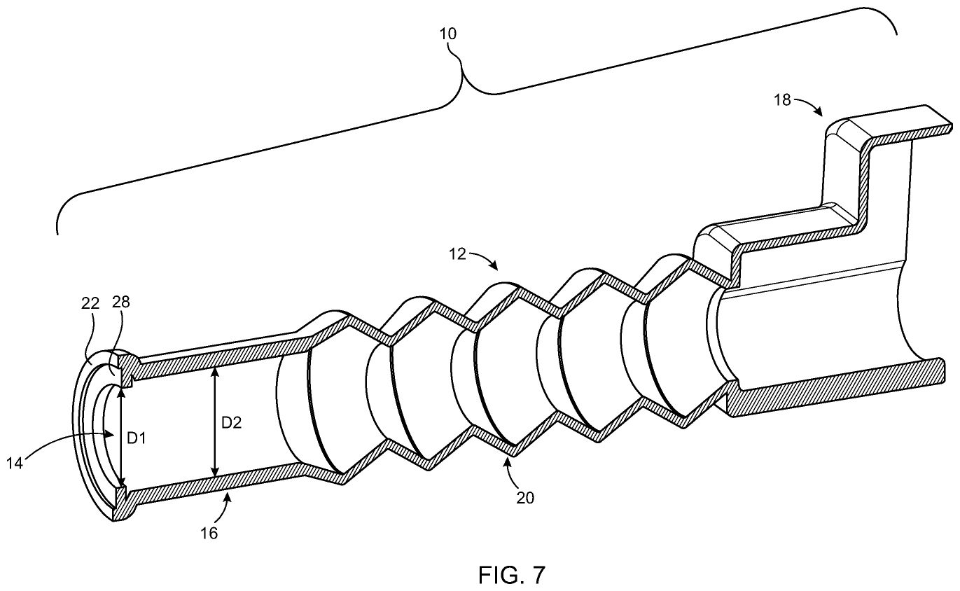

With reference now to FIG. 7, a cross-sectional view of the connector protector 10 is provided. The ring 28 includes an inner diameter D1 which is configured to bound an outer circumferential surface 102a of the wire 102. The inner surface of the ring 28 may be dimensioned to engage the outer circumferential surface 102a of the wire 102 or may be dimensioned to be spaced apart from the outer circumferential surface 102a of the wire 102. The inner diameter D1 of the ring 28 is smaller than the inner diameter D2 of the mouth portion 16 of the body member 12.

In instances where the ring 28 is formed as a separate piece, the lip 22 may be configured to retain the ring 28. For instance, the lip 22 may include an annular ledge 30 which is recessed with respect to a distal end of the lip 22. The ring 28 may be then disposed within the lip 22. The annular ledge 30 presenting a planar surface for which the back surface of the ring 28 may be seated on.

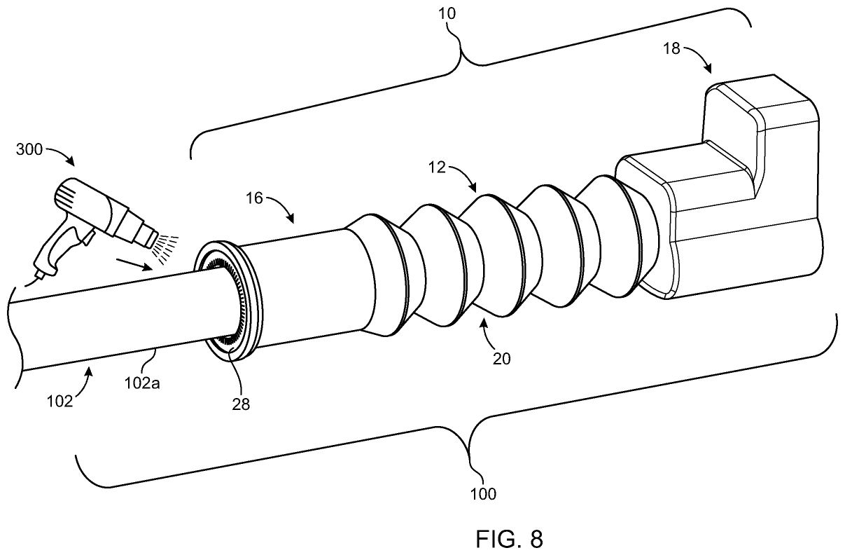

With reference now to FIG. 8, a depiction showing the formation of a water tight seal is provided. The ring 28 includes an inner diameter D1 which is configured to bound an outer circumferential surface 102a of the wire 102. The inner surface of the ring 28 may be dimensioned to engage the outer circumferential surface 102a of the wire 102 or may be dimensioned to be spaced apart from the outer circumferential surface 102a of the wire 102.

The inner diameter D1 of the ring 28 is smaller than the inner diameter D2 of the mouth portion 16 of the body member 12. The wire 102 is inserted into the mouth portion 16 and into the body member 12 and the ring 28 is melted so as to fuse the ring 28 with the mouth portion 16 forming a water tight seal. In particular, a heat source 300 is brought close to the ring 28, as indicated by the arrow, so as to melt the ring 28.

In a preferred embodiment, the wire 102 includes a sheath 102a. The sheath 102a, the ring 28 and the mouth portion 16 are formed of the same material. Preferably, the sheath 102a, the ring 28 and the mouth portion 16 are formed of a thermoplastic polyurethane. Accordingly, the heat source 300 is configured to melt the ring 28 so as to fuse the ring 28 with both the sheath 102a and the mouth portion 16.

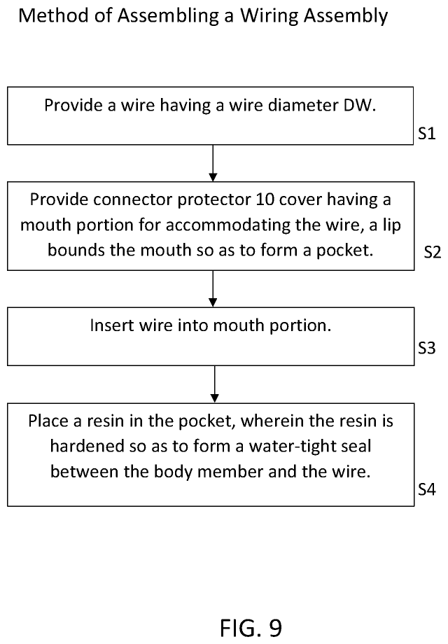

With reference now to FIG. 9, a method of assembling a wiring assembly 100 is also provided. The method includes the step S1, providing a wire 102 having a wire diameter DW and step S2 providing a connector protector 10 cover having a body member 12. The body member 12 includes a through hole 14 for accommodating the wire 102. One end of the body member 12 includes a mouth portion 16 and the other end includes a connector cover portion 18 configured to cover an electrical connector 104. The mouth portion 16 includes a lip 22 having a first diameter that is greater than a second diameter of a through-hole of the body member 12. The second diameter is greater than the wire diameter DW.

With reference also to FIG. 5, the method proceeds to step S3, inserting the wire 102 into the mouth portion 16 and the through hole 14, wherein the space between the outer surface of the wire 102 and the inner surface of the mouth and the body member 12 defines a pocket 24 that bounds a circumference of the wire 102. The method proceeds to step S4, placing a resin 26 in the pocket 24, wherein the resin 26 is hardened so as to form a water-tight seal between the body member 12 and the wire 102. It should be appreciated that the steps S3 and S4 do not need to be performed in any chronological order. FIG. 5 shows one aspect where the wire 102 is seated into the mouth and the resin 26 is then later heated with a heat source, wherein the melted resin 26 is disposed within the pocket 24, fusing with the body member 12. However, the resin 26 may be heated around the inner surface of the mouth and the wire 102 then inserted into the mouth.

In one aspect of the method, as shown in FIG. 5, the lip 22 includes an angled surface extending radially from a center of the lip 22 so as to narrow in a direction from the lip 22 to the body member 12. The body member 12 is a formed of a thermoplastic polyurethane and the resin 26 is formed by melting a thermoplastic polyurethane. It should be appreciated that the wire 102 includes a sheath that is also formed of a thermoplastic polyurethane. In such an aspect, the resin 26, the body member 12 and the sheathed are all fused together so as to form a water tight seal between the connector protector 10 and the wire 102.

With reference now to FIGS. 8 and 9 another aspect of the method the method is provided wherein the resin 26 is in the form of a ring 28. The ring 28 may be formed of the same material as the connector protector 10. The material being a pliable material which may melt. Any such material currently known or later developed may be modified for use herein, illustratively including a thermoplastic polyurethane. The ring 28 is melted so as to fuse with the body member 12 and the wire 102. As shown in FIG. 7, the method may include the step of forming an annular ledge 30 in the lip 22. The annular ledge 30 is recessed with respect to a distal end of the lip 22 and the ring 28 is disposed within the lip 22.

Accordingly, a connector protector 10 and a method of assembling a wiring assembly 100 is provided that closes any gap resulting from a manufacturing 28 tolerances so as to form a water tight seal between the mouth of a connector protector 10 and the wire 102.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A connector protector for protecting an electrical connection between a wire and an electrical connector, the connector protector comprising:
a body member having a through hole for accommodating the wire, wherein one end of the body member includes a mouth portion and the other end includes a connector cover portion configured to cover the electrical connector; and wherein
the mouth portion includes a lip having a first diameter that is greater than a second diameter of the through-hole of the body member is as to define a pocket, the pocket bounding a circumference of the wire and is configured to hold a resin so as to form a water-tight seal between the body and the wire.

2. The connector protector as set forth in claim 1, wherein the lip includes an angled surface extending radially from a center of the lip so as to narrow in a direction from the lip to the body member.

3. The connector protector as set forth in claim 1, wherein the body member is formed of a thermoplastic polyurethane and the resin is a melted thermoplastic polyurethane.

4. The connector protector as set forth in claim 1, further including a ring, the ring disposed within the lip.

5. The connector protector as set forth in claim 4, wherein the lip includes an annular ledge which is recessed with respect to a distal end of the lip and the ring is disposed within the lip.

6. The connector protector as set forth in claim 5, wherein the body member and the ring are made of a same material.

7. The connector protector as set forth in claim 7, wherein the same material is thermoplastic polyurethane.

8. A method of assembling a wiring member, the method comprising the steps of:
providing a wire having a wire diameter;
providing a connector protector cover having a body member, the body member having a through hole for accommodating the wire, wherein one end of the body member includes a mouth portion and the other end includes a connector cover portion configured to cover the electrical connector; and wherein the mouth portion includes a lip having a first diameter that is greater than a second diameter of a through-hole of the body member is as to define a pocket, the pocket bounding a circumference of the wire;
placing the wire into the through hole;
placing a resin in the pocket, wherein the resin is hardened so as to form a water-tight seal between the body member and the wire.

9. The method as set forth in claim 8, wherein the lip includes an angled surface extending radially from a center of the lip so as to narrow in a direction from the lip to the body member.

10. The method as set forth in claim 9, wherein the body member is a formed of a thermoplastic polyurethane and the resin is formed by melting a thermoplastic polyurethane.

11. The method as set forth in claim 10, wherein the wire includes a sheath, the sheath is formed of a thermoplastic polyurethane.

12. The methods as set forth in claim 8, wherein the resin is in the form of a ring, and the ring is formed of a thermoplastic polyurethane, the ring is melted so as to fuse with the body member and the wire.

13. The method as set forth in claim 12, further including the step of forming an annular ledge in the lip, the annular ledge being recessed with respect to a distal end of the lip and the ring is disposed within the lip.
